(19) United States
(12) Patent Application Publication
(10) Pub. No.: US 2009/0244388 A1
(43) Pub. Date: Oct. 1, 2009

(54) MOTION ESTIMATION METHOD AND RELATED APPARATUS FOR DETERMINING TARGET MOTION VECTOR ACCORDING TO MOTION OF NEIGHBORING IMAGE BLOCKS

(76) Inventors: Siou-Shen Lin, Taipei County (TW); Chin-Chuan Liang, Taichung City (TW); Te-Hao Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/056,279

(22) Filed: Mar. 27, 2008

(51) Int. Cl. H04N 5/14

(52) U.S. Cl. 348/699; 348/E05.062

(57) ABSTRACT

A motion estimation method for determining a target motion vector includes calculating a plurality of block matching differences associated with a plurality of candidate motion vectors, determining a plurality of candidate block matching differences according to the block matching differences and motion of a plurality of neighboring image blocks associated with a target image block, and selecting a vector corresponding to a minimum block matching difference among the candidate block matching differences as the target motion vector.

### BACKGROUND

The present invention relates to a video processing scheme, and more particularly, to a motion estimation method and related apparatus for determining a target motion vector.

Generally speaking, an objective of a conventional motion estimator is to generate motion vector (MV) for coding or tracking, etc . . . . The block-matching motion estimation is generally adapted to find the best-matched block. One of conventional method for estimating the motion vector of an image block is to calculate a minimum difference between a current image block and a previous image block, having the same image with the current image block. The conventional method, such as best block matching, might be just enough for video coding application purpose since the video coding normally only need to know the smallest residue, which is calculated with the current block, the previous block and some other predetermined criteria. The detail is omitted for brevity. However, for some other applications, such as tracking or frame rate conversion, the factor of finding the true motion is more important than the best matched block.

For example, if image blocks within an image area have no obvious texture feature, there is a possibility that calculated motion vectors associated with these image blocks through motion estimation are very different from each other. Suppose that two image blocks B₁ and B₂ are adjacent blocks and both blocks correspond to the same object. After applying the conventional motion estimation to the frame rate conversion, it is possible that a residual value of an absolute difference between the image block B₁ and an image block B₁′ referenced by a motion vector V₁ of the image block B₁ is a minimum value and a residual value of an absolute difference between the image block B₂ and an image block B₂′ referenced by a motion vector V₂ of the image block B₂ is also a minimum value. However, the motion vector V₁ may be rather different from the motion vector V₂, e.g., a vector (0,0) for V₁ vs. a vector (2,0) for V₂. More seriously, the motion vectors of more than two adjacent image blocks are substantially different from each other. The calculated motion vectors of the image blocks being different means that actual motion of the image blocks is different to some extent, and it is very difficult to decide how to generate desired interpolated frames according to the motion vectors since the image blocks correspond to the same object. Also, the different motion vectors will cause some interpolation errors when performing the frame rate conversion.

### SUMMARY

Therefore one of the objectives of the present invention is to provide a motion estimation method and related apparatus capable of determining a target motion vector according to the motion of neighboring image blocks, to solve the above-described problem.

According to embodiments of the present invention, a motion estimation method for determining a target motion vector is disclosed. The motion estimation method comprises calculating a plurality of block matching differences associated with a plurality of candidate motion vectors, determining a plurality of candidate block matching differences according to the block matching differences and motion of a plurality of neighboring image blocks associated with a target image block, and selecting a vector corresponding to a minimum block matching difference among the candidate block matching differences as the target motion vector.

According to the embodiments of the present invention, a motion estimation apparatus for determining a target motion vector is disclosed. The motion estimation apparatus comprises a calculating unit, a decision unit, and a selecting unit. The calculating unit is utilized for calculating a plurality of block matching differences associated with a plurality of candidate motion vectors. The decision unit is coupled to the calculating unit and utilized for determining a plurality of candidate block matching differences according to the block matching differences and motion of a plurality of neighboring image blocks associated with a target image block. Finally, the selecting unit is coupled to the decision unit and utilized for selecting a vector corresponding to a minimum block matching difference among the candidate block matching differences as the target motion vector.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a motion estimation apparatus according to embodiments of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

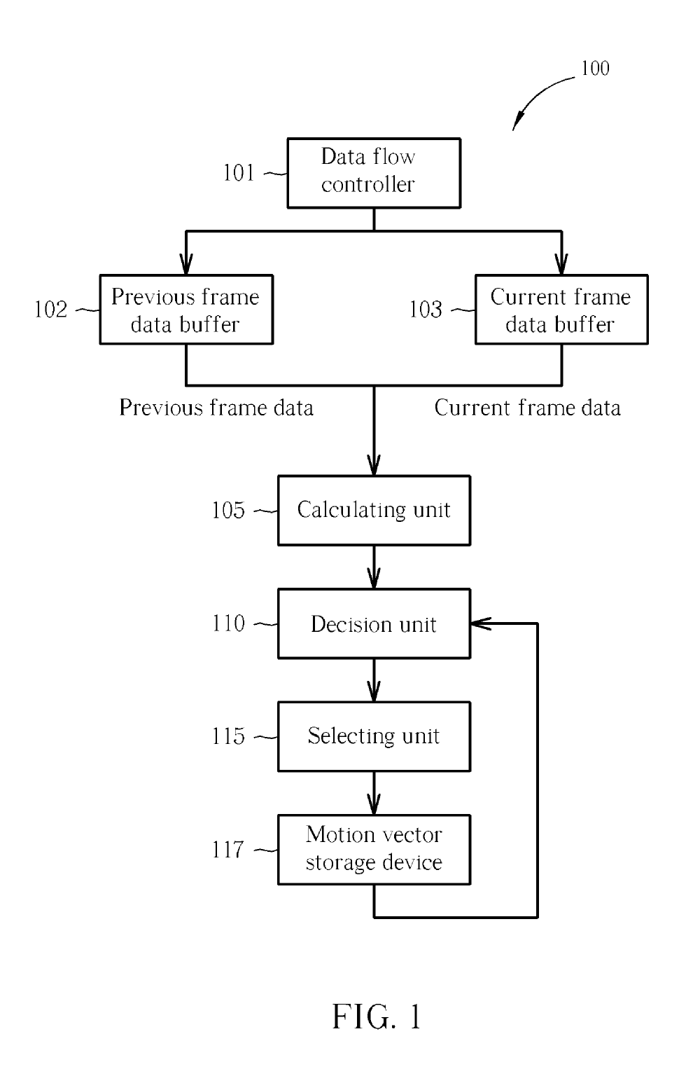

Please refer to FIG. 1. FIG. 1 is a diagram of a motion estimation apparatus 100 according to first and second embodiments of the present invention. As shown in FIG. 1, the motion estimation apparatus 100 includes a data flow controller 101, a previous frame data buffer 102, a current frame data buffer 103, a calculating unit 105, a decision unit 110, a selecting unit 115, and a motion vector storage device 117. The motion estimation apparatus 100 is utilized for estimating actual motion of objects corresponding to image blocks to determine target motion vectors. The data flow controller 101 controls the previous and current frame data buffers 102 and 103 to output previous and current frame data, respectively. The previous frame data outputted from the previous frame data buffer 102 is full frame data or partial frame data, and the current frame data outputted from the current frame data buffer 103 are full frame data or partial frame data. For determining a target motion vector of each target image block in accordance with the previous and current frame data, the calculating unit 105 calculates a plurality of block matching differences associated with a plurality of candidate motion vectors of the target image block. The decision unit 110 then determines a plurality of candidate block matching differences according to the block matching differences and the motion of a plurality of neighboring image blocks associated with the target image block. Finally, the selecting unit 115 selects a vector corresponding to a minimum block matching difference among the candidate block matching differences as the target motion vector and transmits this target motion vector to the motion vector storage device 117. Each block matching difference in the embodiments is intended to be a sum of absolute pixel differences (SAD) between two image blocks but this is not intended to be a limitation of the present invention.

Particularly, in the first embodiment, when a total number of these neighboring image blocks determined to have motion is equal to or greater than a threshold value, the decision unit 110 combines one or more penalty values with the one or more block matching differences generated by the calculating unit 105 to generate the candidate block matching differences, respectively. Otherwise, when the total number is smaller than the threshold value, the decision unit 110 directly utilizes the block matching differences as the candidate block matching differences. That is, if objects corresponding to most of the neighboring image blocks are estimated as moving objects, one or more penalty values are combined with block matching difference(s) corresponding to one or more specific candidate motion vectors, so as to prevent the selecting unit 115 from selecting an undesired target motion vector. An estimation of the motion of the neighboring image blocks is executed according to motion vectors of these neighboring image blocks, where these motion vectors are sent from the motion vector storage device. Of course, combining only one penalty value with a block matching difference corresponding to a specific motion vector can also be used to aid the determination of a preferred target motion vector.

For example, a penalty value (i.e., a zero penalty term) associated with a zero vector (0,0) is used for avoiding selecting this zero vector as the target motion vector when most of the neighboring image blocks are determined to have motion. The zero penalty term causes the value of this block matching difference to increase, and there is a higher possibility that the increased block matching difference (i.e., the candidate block matching difference) is not a minimum block matching difference. Thus, the zero vector (0,0) is not selected as the target motion vector. As a result, dynamically combining the zero penalty term with the block matching difference associated with the zero vector can reduce motion discontinuity. Besides, it can also avoid the problem where a singular penalty term may bring about an erroneous motion vector. It should be noted that other types of penalty terms besides the zero penalty term can also be applied to the first embodiment for decreasing motion discontinuity. Moreover, in practice, combining the zero penalty value with the above-mentioned block matching difference can also be replaced by combining a great zero penalty value with this block matching difference and combining other small penalty values with other block matching differences. These modifications also fall within the scope of the present invention.

In the second embodiment, instead of dynamically applying one or more penalty terms, the motion estimation apparatus 100 first analyzes motion characteristic of the neighboring image blocks according to a plurality of motion vectors associated with the neighboring image blocks. Specifically, the decision unit 110 calculates a reference motion vector according to the motion vectors associated with the neighboring image blocks, where the reference motion vector is a median result of these motion vectors in the second embodiment. Please note that the median result is not meant to be a limitation of the present invention; other calculation results, such as an average result of the above-mentioned motion vectors, can also be applied to the second embodiment. The decision unit 110 then compares the reference motion vector with the candidate motion vectors to obtain the penalty values and combines the penalty values with the block matching differences to calculate the candidate block matching differences, respectively.

Particularly, the decision unit 110 figures out absolute values of the vector differences between the reference motion vector and each of the motion vectors and takes the absolute values as the penalty values. The decision unit 110 then adds the penalty values to the block matching differences, respectively, to obtain the candidate block matching differences. Finally, the selecting unit 115 selects a vector, corresponding to a minimum block matching difference among the candidate block matching differences, as the target motion vector. For frame rate conversion or tracking (since there is a contradiction if a finally determined target motion vector of a target image block is very different from those of neighboring image blocks), a higher penalty value is added to a block matching difference associated with a candidate motion vector in this embodiment when the difference between this candidate motion vector and motion vectors of the neighboring image blocks is greater. Consequently, the candidate motion vector having the greater difference compared to the motion vectors of the neighboring image blocks will not be selected as the target motion vector, even though this candidate motion vector corresponds to an original minimum block matching difference (that is, it is not a minimum candidate block matching difference). For the frame rate conversion or tracking, the finally determined target motion vectors of the target and neighboring image blocks will become smoother, and it also means that the actual motion of the target and neighboring image blocks will be similar. Therefore, interpolation errors are not introduced.

In addition, the first and second embodiments can also be integrated together as another embodiment. That is, when the total number of these neighboring image blocks having motion is equal to or greater than the threshold value, the decision unit 110 computes the reference motion vector and compares the reference motion vector with the motion vectors of the neighboring image blocks for generating the candidate block matching differences. When the total number is smaller than the threshold value, the decision unit 110 directly utilizes the block matching differences as the candidate block matching differences. This also obeys the spirit of the present invention. Furthermore, it is optional for the selecting unit 115 to send each determined target motion vector to the motion vector storage device 117; information of the motion vectors of the neighboring image blocks can be obtained from an external device.

Those skilled in the art will readily observe that numerous modifications and alterations of the device and method may be made while retaining the teachings of the invention.

What is claimed is:

1. A motion estimation method for determining a target motion vector, comprising:
calculating a plurality of block matching differences associated with a plurality of candidate motion vectors;
determining a plurality of candidate block matching differences according to the block matching differences and motions of a plurality of neighboring image blocks associated with a target image block; and
selecting a vector corresponding to a minimum block matching difference among the candidate block matching differences as the target motion vector.

2. The motion estimation method of claim 1, wherein the step of determining the candidate block matching differences comprises:
when a total number of neighboring image blocks having motion is equal to or greater than a threshold value, combining a plurality of penalty values with the block matching differences to generate the candidate block matching differences, respectively; and
when the total number is smaller than the threshold value, directly utilizing the block matching differences as the candidate block matching differences.

3. The motion estimation method of claim 2, wherein the step of combining the penalty values with the block matching differences to generate the candidate block matching differences comprises:
calculating a reference motion vector according to a plurality of motion vectors associated with the neighboring image blocks;
comparing the reference motion vector with the candidate motion vectors to obtain the penalty values, respectively; and
combining the penalty values with the block matching differences to calculate the candidate block matching differences, respectively.

4. The motion estimation method of claim 3, wherein the reference motion vector is a median result of the motion vectors associated with the neighboring image blocks.

5. The motion estimation method of claim 1, wherein the step of determining the candidate block matching differences comprises:
calculating a reference motion vector according to a plurality of motion vectors associated with the neighboring image blocks;
comparing the reference motion vector with the candidate motion vectors to obtain a plurality of penalty values, respectively; and
combining the penalty values with the block matching differences to calculate the candidate block matching differences, respectively.

6. The motion estimation method of claim 5, wherein the reference motion vector is a median result of the motion vectors associated with the neighboring image blocks.

7. A motion estimation apparatus for determining a target motion vector, comprising:
a calculating unit, for calculating a plurality of block matching differences associated with a plurality of candidate motion vectors;
a decision unit, coupled to the calculating unit, for determining a plurality of candidate block matching differences according to the block matching differences and motion of a plurality of neighboring image blocks associated with a target image block; and
a selecting unit, coupled to the decision unit, for selecting a vector corresponding to a minimum block matching difference among the candidate block matching differences as the target motion vector.

8. The motion estimation apparatus of claim 7, wherein the decision unit combines a plurality of penalty values with the block matching differences to generate the candidate block matching differences, respectively, when a total number of neighboring image blocks with motion is equal to or greater than a threshold value; and the decision unit directly utilizes the block matching differences as the candidate block matching differences when the total number is smaller than the threshold value.

9. The motion estimation apparatus of claim 8, wherein the decision unit calculates a reference motion vector according to a plurality of motion vectors associated with the neighboring image blocks and compares the reference motion vector with the candidate motion vectors to obtain the penalty values, respectively; and then the decision unit combines the penalty values with the block matching differences to calculate the candidate block matching differences, respectively.

10. The motion estimation apparatus of claim 9, wherein the reference motion vector is a median result of the motion vectors associated with the neighboring image blocks.

11. The motion estimation apparatus of claim 7, wherein the decision unit calculates a reference motion vector according to a plurality of motion vectors associated with the neighboring image blocks and compares the reference motion vector with the candidate motion vectors to obtain a plurality of penalty values, respectively; and then the decision unit combines the penalty values with the block matching differences to calculate the candidate block matching differences, respectively.

12. The motion estimation apparatus of claim 11, wherein the reference motion vector is a median result of the motion vectors associated with the neighboring image blocks.
